(19) United States
(12) Patent Application Publication
(10) Pub. No.: US 2017/0160587 A1
(43) Pub. Date: Jun. 8, 2017

(54) LIQUID CRYSTAL DISPLAY ASSEMBLY AND ELECTRONIC DEVICE

(71) Applicant: XIAOMI INC., Beijing (CN)

(72) Inventors: Guosheng LI, Beijing (CN); Zhongsheng JIANG, Beijing (CN); Shuangquan PAN, Beijing (CN)

(73) Assignee: XIAOMI INC., Beijing (CN)

(21) Appl. No.: 15/367,471

(22) Filed: Dec. 2, 2016

(30) Foreign Application Priority Data
Dec. 2, 2015 (CN) 201510872857.7

(51) Int. Cl. G02F 1/1335; G02F 1/1362; G01S 15/08; G02F 1/1368

(52) U.S. Cl. CPC G02F 1/133528; G02F 1/1368; G02F 1/133514; G02F 1/133512; G02F 1/136286; G01S 15/08; G02F 2001/133302

(57) ABSTRACT

A liquid crystal display assembly and an electronic device are provided in the field of display technology. The liquid crystal display assembly includes: an upper substrate; a lower substrate disposed parallel to the upper substrate; a liquid crystal layer enclosed between the upper and lower substrates; an upper polarizer attached to a side of the upper substrate not adjacent to the liquid crystal layer; a lower polarizer attached to a side of the lower substrate not adjacent to the liquid crystal layer; at least one supersonic wave sensor; and a control chip. The at least one supersonic wave sensor is arranged between the upper and lower polarizers, and each supersonic wave sensor is electrically connected to the control chip.

### CROSS-REFERENCE TO RELATED APPLICATION

This application is based on and claims priority of the Chinese Patent Application No. 201510872857.7, filed on Dec. 2, 2015, which is incorporated herein by reference in its entirety.

### TECHNICAL FIELD

The present disclosure is related to the field of display technology, and more particularly, to a liquid crystal display assembly and an electronic device.

### BACKGROUND

An electronic device is provided with an optical proximity sensor to detect whether there is an object approaching the electronic device.

In the related arts, a small aperture is opened on a front surface of a housing of an electronic device and near the upper edge of the housing, and an optical proximity sensor is provided in the aperture. Taking a handset as an example, typically, a small aperture is opened on a side of a housing where the screen of the handset is provided, and an optical proximity sensor is provided in the small aperture.

### SUMMARY

The present disclosure provides a liquid crystal display assembly and an electronic device as below to solve the problems in the related arts.

According to a first aspect of embodiments of the present disclosure, there is provided a liquid crystal display assembly, comprising: an upper substrate; a lower substrate disposed parallel to the upper substrate; a liquid crystal layer enclosed between the upper and lower substrates; an upper polarizer attached to a side of the upper substrate away from the liquid crystal layer; a lower polarizer attached to a side of the lower substrate away from the liquid crystal layer. The liquid crystal display assembly further comprises at least one supersonic wave sensor and a control chip. The at least one supersonic wave sensor is arranged between the upper and lower polarizers, and each supersonic wave sensor is electrically connected to the control chip.

According to a second aspect of embodiments of the present disclosure, there is provided an electronic device comprising a liquid crystal display assembly according to the first aspect.

It should be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a schematic structural diagram showing a liquid crystal display assembly according to an exemplary embodiment;

FIG. 2 is a schematic structural diagram showing a liquid crystal display assembly according to another exemplary embodiment;

FIG. 3 is a schematic diagram showing different arrangements of pixel color blocks in a CF according to an exemplary embodiment;

FIG. 4 is a side view of a CF according to an exemplary embodiment;

FIG. 5A is a side view of a lower glass substrate according to an exemplary embodiment;

FIG. 5B is a side view of an upper substrate according to another exemplary embodiment;

FIG. 5C is a side view of a lower glass substrate according to another exemplary embodiment;

FIG. 5D is a side view of an upper substrate according to another exemplary embodiment;

FIG. 5E is a side view of a lower glass substrate according to another exemplary embodiment; and

FIG. 6 is a schematic diagram showing a display region corresponding to a liquid crystal display assembly according to an exemplary embodiment.

### DETAILED DESCRIPTION

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Reference will now be made in detail to embodiments, examples of which are illustrated in the accompanying drawings. The following description refers to the accompanying drawings in which the same numbers in different drawings represent the same or similar elements unless otherwise indicated. The implementations set forth in the following description of embodiments do not represent all implementations consistent with the disclosure. Instead, they are merely examples of apparatuses and methods consistent with aspects related to the disclosure as recited in the appended claims.

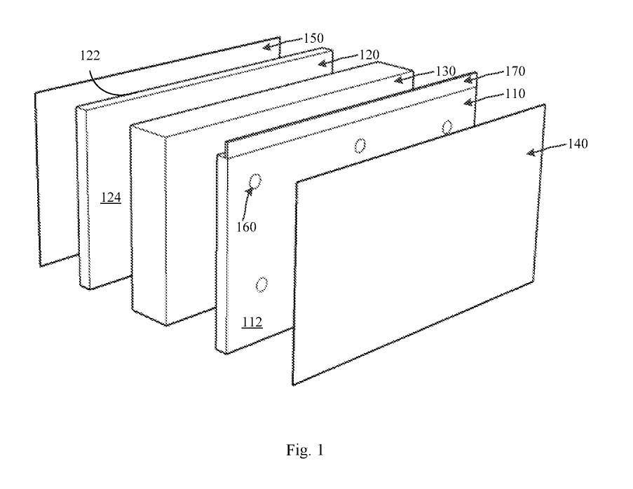

FIG. 1 is a schematic structural diagram showing a liquid crystal display assembly according to an exemplary embodiment. As shown in FIG. 1, the liquid crystal display assembly includes: an upper substrate 110; a lower substrate 120 disposed parallel to the upper substrate 110; a liquid crystal layer 130 enclosed between the upper and lower substrates 110 and 120; an upper polarizer 140 attached to a side 112 of the upper substrate 110 away from the liquid crystal layer 130; and a lower polarizer 150 attached to a side 122 of the lower substrate 120 away from the liquid crystal layer 130. Here, the side 112 and side 122 may not be adjacent to the liquid crystal layer 130. The lower substrate includes a first side 122 and a second side 124 opposite to each other while the second side 124 may be disposed directly on the liquid crystal layer 130.

As shown in FIG. 1, the liquid crystal display assembly further includes: at least one supersonic wave sensor 160 and a control chip 170. The at least one supersonic wave sensor 160 is arranged between the upper and lower polarizers 140 and 150, and each supersonic wave sensor 160 is electrically connected to the control chip 170.

To sum up, by arranging the supersonic wave sensor between the upper and lower polarizers to detect whether there is an object approaching an electronic device, the liquid crystal display assembly of this disclosure solves the problem of the unpleasant appearance of the electronic device in the related arts caused by opening an aperture for arranging therein an optical proximity sensor to detect whether there is an object approaching an electronic device, and achieves the effects of eliminating the need for opening an aperture, saving the area of the front panel of the electronic device, and improving the design beauty of the electronic device.

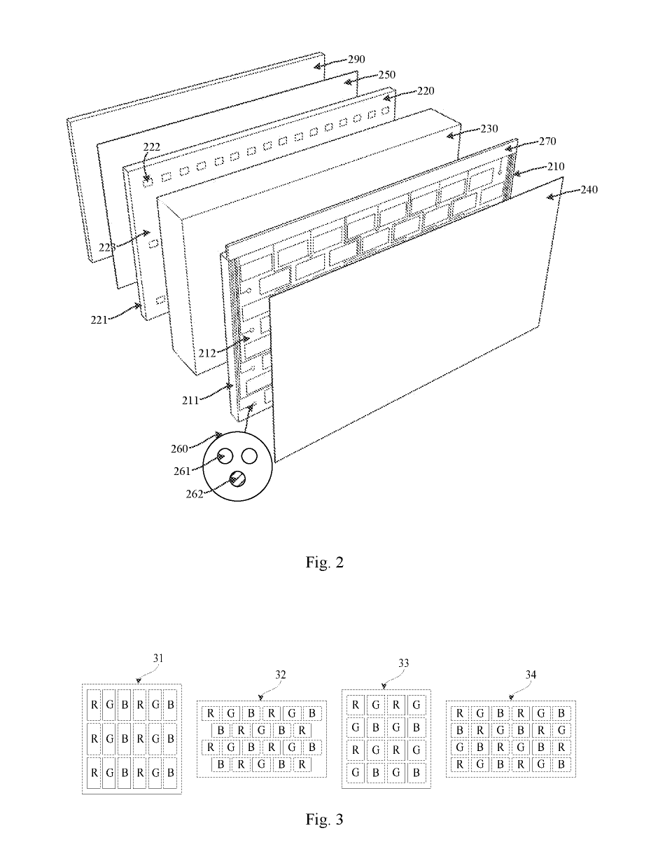

FIG. 2 is a schematic diagram showing a liquid crystal display assembly according to another exemplary embodiment. The liquid crystal display assembly may be a liquid crystal display (LCD) panel of an electronic device, such as a handset, a tablet, a laptop, a smart TV, or the like.

As shown in FIG. 2, the liquid crystal display assembly includes: an upper substrate 210; a lower substrate 220 disposed parallel to the upper substrate 210; a liquid crystal layer 230 enclosed between the upper and lower substrates 210 and 220; an upper polarizer 240 attached to a side 215 of the upper substrate 210 not adjacent to the liquid crystal layer 230; and a lower polarizer 250 attached to a side 225 of the lower substrate 220 not adjacent to the liquid crystal layer 230.

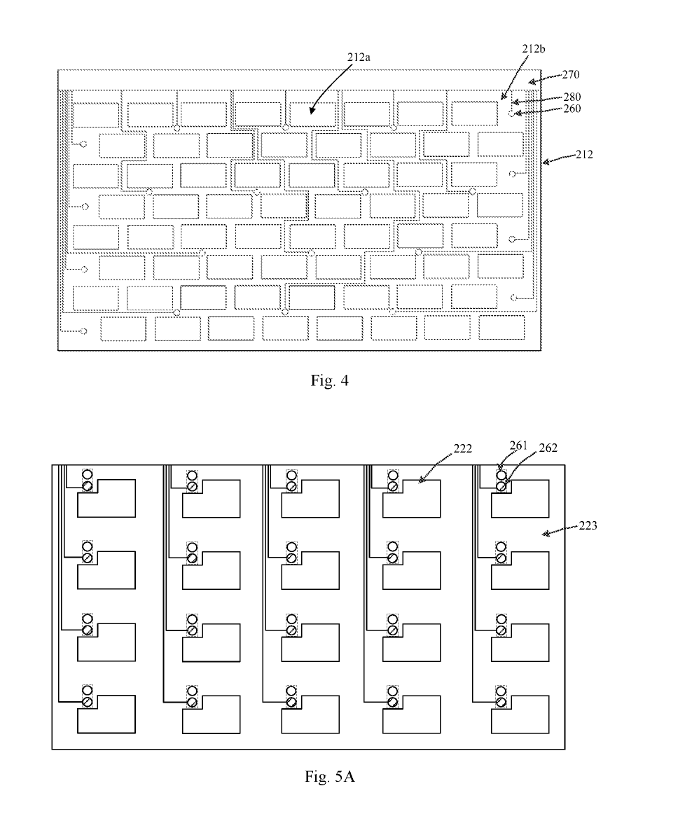

Optionally, as shown in FIG. 2, the upper substrate 210 comprises an upper glass substrate 211 and a CF 212. A lower surface of the upper glass substrate 211 is adjacent to the liquid crystal layer 230. The CF 212 is attached to an upper surface of the upper glass substrate 211. The CF 212 enables a LCD panel to present a color image, and a plurality of different pixel color blocks corresponding to three colors R, G and B are arranged on the CF 212. FIG. 3 exemplarily shows several different arrangements of the pixel color blocks in the CF. In a first possible arrangement, on CF 31 as shown, different pixel color blocks corresponding to three colors R, G and B are arranged in a strip. In a second possible arrangement, on CF32 as shown, different pixel color blocks corresponding to three colors R, G and B are arranged in a triangle. In a third possible arrangement, on CF33 as shown, different pixel color blocks corresponding to three colors R, G and B are arranged in a square. In a fourth possible arrangement, on CF 34 as shown, different pixel color blocks corresponding to three colors R, G and B are arranged are arranged in a mosaic pattern (also referred to as “being diagonally arranged”). Of course, several arrangement manners as shown in FIG. 3 are merely exemplary and explanatory, and there are other possible arrangements not defined in this embodiment.

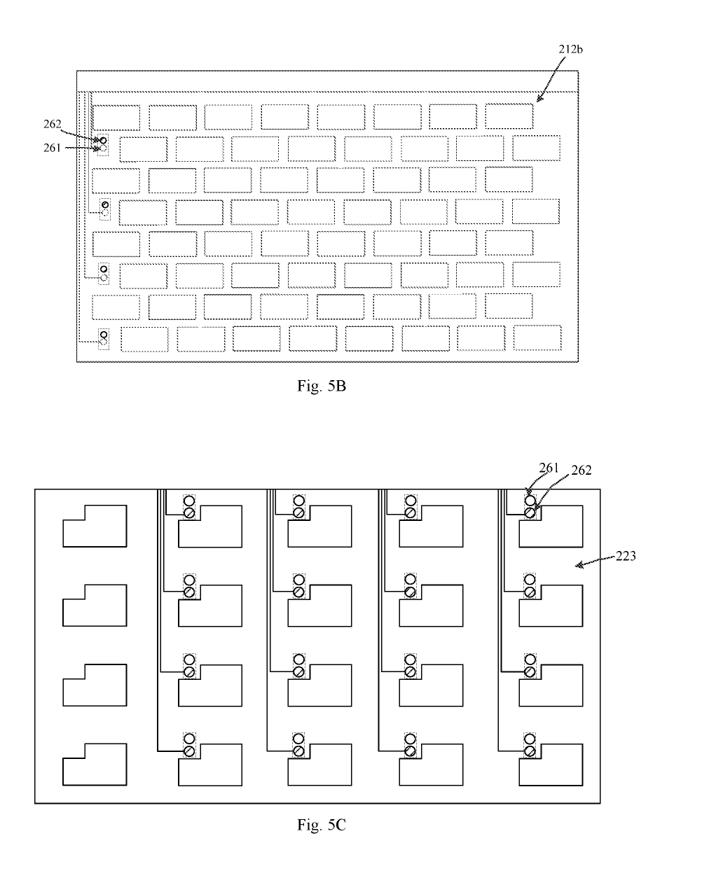

In addition, referring to FIG. 2 and FIG. 4, FIG. 4 shows a side view of the CF 212. The CF 212 comprises pixel color blocks 212a and a first black matrix 212b arranged between the pixel color blocks 212a. The pixel color blocks 212a are different pixel color blocks corresponding to three colors R, G and B. The first black matrix 212b is arranged between the pixel color blocks 212a. The first black matrix 212b is used for preventing leakage of background light, improving display contrast of the LCD panel, preventing color mixing and increasing the purity of colors.

Optionally, as shown in FIG. 2, the lower substrate 220 comprises a lower glass substrate 221 and a TFT array 222. An upper surface of the lower glass substrate 221 is adjacent to the liquid crystal layer 230; and a lower surface of the lower glass substrate 221 is provided with the TFT array 222 and a second black matrix 223 arranged between TFTs of the TFT arrays 222.

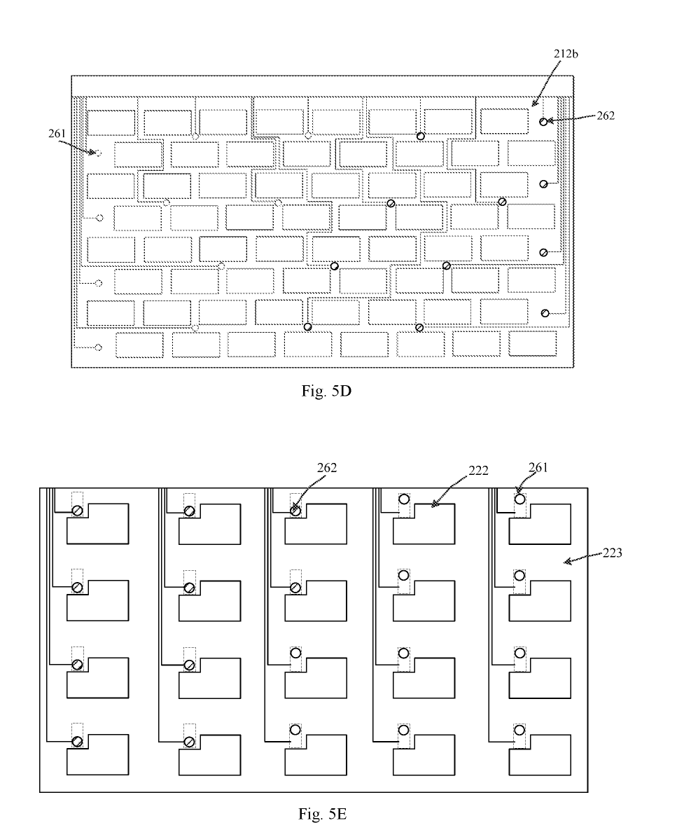

FIG. 5A is a side view of the lower glass substrate 221. The second black matrix 223 is used for preventing leakage of background light, improving the display contrast of the LCD panel, preventing color mixing and increasing the purity of colors.

As shown in FIG. 2, the liquid crystal display assembly further comprises: at least one supersonic wave sensor 260 and a control chip 270. The supersonic wave sensor 260 may be arranged between the upper polarizer 240 and a lower polarizer 250 and is electrically connected to the control chip 270. For example, each supersonic wave sensor 260 may be arranged between the upper polarizer 240 and the lower polarizer 250. Each supersonic wave sensor 260 is used for converting a supersonic wave signal into an electric signal and providing the electric signal to the control chip 270. The supersonic wave sensor 260 may be disposed on the side 215 of the upper substrate 210.

Each supersonic wave sensor 260 may include at least one transmitting terminal 261 and one receiving terminal 262, or comprises one transmitting terminal 261 and at least one receiving terminal 262. The transmitting terminal 261 and the receiving terminal 262 alternately work under control of the control chip 270. That is, when the transmitting terminal 261 works, the receiving terminal 262 does not work; and when the receiving terminal 262 works, the transmitting terminal 261 does not work. For different supersonic wave sensors 260, the frequency at which the transmitting terminal 261 and the receiving terminal 262 alternately work may be identical or different, which will not be limited in this embodiment.

The transmitting terminal 261 of each supersonic wave sensor 260 is used for transmitting supersonic wave signals. When there is an object approaching, the supersonic wave signals will be blocked by the object to form reflected signals, and the receiving terminal 262 is used for receiving the reflected signals. An electronic device may detect whether there is an object approaching by detecting whether the receiving terminal 262 in the supersonic wave sensor 260 receives reflected signals.

In addition, a timing module may also be arranged in the supersonic wave sensor 260 to detect a distance between an approaching object and the liquid crystal display assembly. The timing module starts timing when the transmitting terminal 261 transmits a supersonic wave signal and stops timing when the receiving terminal 262 receives a reflected signal of the supersonic wave signal, to obtain a timing duration. The supersonic wave sensor 260 reads the timing duration in the timing module and determines the timing duration as a duration t of a transceiving process of the supersonic wave signal.

The distance between the approaching object and the liquid crystal display assembly may be obtained according to a formula: s=v*t/2,

Here, v denotes a sound velocity, t denotes the duration of said transceiving process, and s denotes the distance between the approaching object and the liquid crystal display assembly.

Because the sound velocity v will change with the temperature, a temperature sensor may be arranged in the supersonic wave sensor. The value of the sound velocity under the current temperature may be obtained according to a formula: v=331.45+0.607T, wherein T denotes a current temperature value obtained by the temperature sensor. Alternatively or additionally, the current temperature value T may also be obtained by reading weather information in the electronic device, which will not be defined in this embodiment.

In the following, arrangements of the supersonic wave sensors 260 will be described. At least one supersonic wave sensor 260 may be arranged on the upper surface of the lower glass substrate 221.

For example, each supersonic wave sensor 260 may be arranged on the upper surface of the lower glass substrate 221, and in this case both the transmitting terminal 261 and the receiving terminal 262 of each supersonic wave sensor 260 are arranged on the upper surface of the lower glass substrate 221. In another example, at least one supersonic wave sensor 260 is arranged on the CF 212. Each supersonic wave sensor 260 may be arranged on the CF 212, and in this case both the transmitting terminal 261 and the receiving terminal 262 of each supersonic wave sensor 260 are arranged on the CF 212; and so on.

When there are provided a plurality of supersonic wave sensors 260 (for example, the number of the at least one supersonic wave sensor is n, n≧2), the n supersonic wave sensors may be evenly and dispersedly arranged on the lower glass substrate 221. The supersonic wave sensors may be evenly and dispersedly arranged on the upper surface of the lower glass substrate 221. The transmitting terminal 261 of each supersonic wave sensor 260 is arranged on at least one of the first black matrix 212b and the second black matrix 223, and the receiving terminal 262 of each supersonic wave sensor 260 is arranged on at least one of the first black matrix 212b and the second black matrix 223.

FIG. 5A illustrates an example in which one supersonic sensor 260 includes one transmitting terminal 261 and one receiving terminal 262. For example, a blank circle represents a transmitting terminal 261 in a supersonic wave sensor 260, a hatched circle represents a receiving terminal 262 in a supersonic wave sensor 260. Both the transmitting terminals 261 and the receiving terminals 262 of supersonic wave sensors 260 are evenly and dispersedly arranged on the second black matrix 223 of the lower glass substrate 221.

As another example, all transmitting terminals 261 of the supersonic wave sensors 260 are dispersedly arranged on the first black matrix 212b, and all receiving terminals 262 thereof are dispersedly arranged on the second black matrix 223; or all the transmitting terminals 261 of the supersonic wave sensors 260 are dispersedly arranged on the second black matrix 223, and all the receiving terminals 262 thereof are dispersedly arranged on the first black matrix 212b.

FIGS. 5B-5C illustrate another example in which the supersonic wave sensors are distributed on two different layers. In FIG. 5B, the transmitting terminals 261 and receiving terminals 262 of a part of supersonic wave sensors 260 are dispersedly arranged on the first black matrix 212b. In FIG. 5C, the transmitting terminals 261 and the receiving terminals 262 of the remaining part of the supersonic wave sensors 260 are dispersedly arranged on the second black matrix 223.

FIGS. 5D-5E illustrate another example in which the supersonic wave sensors are distributed on two different layers. In FIG. 5D, transmitting terminals 261 of a part of supersonic wave sensors 260 are dispersedly arranged on the left portion of first black matrix 212b. In FIG. 5E, the corresponding receiving terminals 262 thereof are dispersedly arranged on the left portion of the second black matrix 223. In the right portion of FIG. 5E, transmitting terminals 261 of the remaining part of supersonic wave sensors 260 are dispersedly arranged on the second black matrix 223. In the right portion of FIG. 5D, the corresponding receiving terminals 262 thereof are dispersedly arranged on the first black matrix 212b.

The arrangement of the transmitting terminals 261 and the receiving terminals 262 of the supersonic wave sensors 260 is not limited in this disclosure.

By providing and evenly and dispersedly arranging the plurality of supersonic wave sensors 260, it can be detected within the whole LCD panel of the electronic device whether there is an object approaching, solving the problem of the unpleasant appearance of the electronic device in the related arts caused by opening an aperture for arranging therein an optical proximity sensor to detect whether there is an object approaching an electronic device, and achieving the effects of eliminating the need for opening an aperture, saving the area of the front panel of the electronic device and improving the design beauty of the electronic device.

In addition, by arranging the transmitting terminal 261 and the receiving terminal 262 of each supersonic wave sensor 260 on the second black matrix 223 or the first black matrix 212b, it can be ensured that the supersonic wave sensor 260 will not affect the optical transmittance of the LCD panel and thus the display effect of the LCD panel. In addition, this prevents the reception by the supersonic wave sensor of reflected signals of supersonic wave signals transmitted by the transmitting terminal from being constrained by transmitting and receiving angles, thereby improving the detection accuracy.

Optionally, referring to FIG. 4, each supersonic wave sensor 260 and the control chip 270 are connected via a conducting wire 280, and each conducting wire 280 is also arranged on the first black matrix 212b of the CF 212 or on the second black matrix 223 of the lower glass substrate 221. By arranging the conducting wire 280 on the first black matrix 212b or the second black matrix 223, it can be ensured that the conducting wire will not affect the optical transmittance of the LCD panel and thus the display effect of the LCD panel. Optionally, the conducting wire 208 may also be made of a transparent material.

As shown in FIG. 2, the liquid crystal display assembly further includes: at least one backlight source 290 electrically connected to the control chip 270. The backlight source 290 is provided at the back of the lower polarizer 250. The backlight source 290 is used for providing a light source at the back of the LED panel. The type of the backlight source 290 includes, but is not limited to, any one of EL (Electro Luminescent), CCFL (Cold Cathode Fluorescent Lamp), LED (Light Emitting Diode), etc.

In addition, the control chip 270 may be an MCU (Microcontroller Unit) which is also referred to as a single-chip microcomputer or a single chip and is a chip-level computer. In one possible implementation, taking an example in which the MCU dynamically controls the backlight luminance according to a distance between a finger and the liquid crystal display assembly calculated by the supersonic wave sensors, the receiving terminal 262 of each supersonic wave sensor 260 collects reflected signals of supersonic wave signals transmitted from the transmitting terminal 261 of the supersonic wave sensor 260. The MCU acquires reflected signals from each supersonic wave sensor 260, performs calculation on the acquired reflected signals, determines whether there is an object approaching within a preset distance from the LCD panel according to the calculation result, and then controls the backlight source 290 to emit light or not to emit light according to the determination result. For example, when the calculation result indicates that there is an object approaching within 1 cm from the LCD panel, the MCU controls the backlight source 290 not to emit light; and when the calculation result indicates that there is no object approaching within 1 cm from the LCD panel, the MCU controls the backlight source 290 to emit light.

Optionally, the preset distance may not be needed in the liquid crystal display assembly. In that case, it is considered that there is an object approaching as long as the MCU receives reflected signals from the receiving terminal 262 of the supersonic wave sensor 260.

In addition, a display area corresponding to the liquid crystal display assembly may be a complete display area which is correspondingly provided with at least one backlight source 290. Each backlight source 290 may control the backlight luminance of the whole display area.

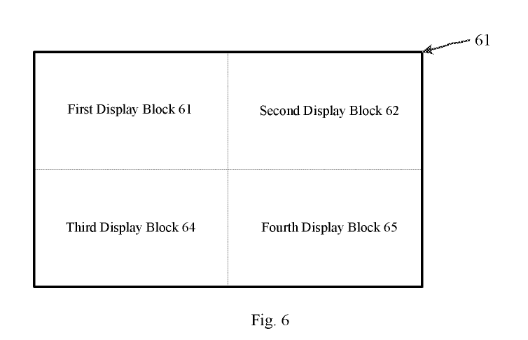

Alternatively or additionally, as shown in FIG. 6, the display area 61 corresponding to the liquid crystal display assembly may be divided into m (m≧2) display blocks (including a first display block 62, a second display block 63, a third display block 64 and a fourth display block 65 as shown). Each display block is correspondingly provided with at least one backlight source 290 and at least one supersonic wave sensor 260. For each display block, a number of backlight sources 290 corresponding thereto are used for solely controlling the backlight luminance of the display block. For example, assuming that the first display block 62 is correspondingly provided with a first backlight source and a first supersonic wave sensor and that the second display block 63 is correspondingly provided with a second backlight source and a second supersonic wave sensor, then the first backlight source is used for solely controlling the backlight luminance of the first display block 62 according to reflected signals collected by the first supersonic wave sensor, and the second backlight source is used for solely controlling the backlight luminance of the second display block 63 according to reflected signals collected by the receiving terminal of the second supersonic wave sensor. By dividing the display area corresponding to the LCD panel into a plurality of display blocks and separately controlling backlight luminances of the plurality of display blocks by using different backlight sources, flexibility of backlight control is improved.

In the disclosure, by arranging the supersonic wave sensor between the upper and lower polarizers to detect whether there is an object approaching an electronic device, the liquid crystal display assembly of this disclosure solves the problem of the unpleasant appearance of the electronic device in the related arts caused by opening an aperture for arranging therein an optical proximity sensor to detect whether there is an object approaching an electronic device, and achieves the effects of eliminating the need for opening an aperture, saving the area of the front panel of the electronic device, and improving the design beauty of the electronic device.

In addition, by arranging at least one transmitting terminal of the supersonic wave sensor on at least one of the first and second black matrices and arranging at least one receiving terminal of the supersonic wave sensor on at least one of the first and second black matrices, it is ensured that the supersonic wave sensor will not affect the optical transmittance of the LCD panel and thus the display effect of the LCD panel. In addition, this prevents the reception by the supersonic wave sensor at its receiving terminal of reflected signals of supersonic wave signals transmitted by the transmitting terminal from being constrained by transmitting and receiving angles, thereby solving the problem that an optical proximity sensor cannot detect an approaching object within the whole LCD panel of the electronic device and achieving the effect of improving the detection accuracy.

Another embodiment of this disclosure provides an electronic device. For example, the electronic device may be a mobile phone, a computer, a digital broadcast terminal, a messaging device, a gaming console, a tablet, a medical device, exercise equipment, a personal digital assistant or the like. The electronic device comprises the liquid crystal display assembly provided by the embodiment shown in FIG. 1 or 2.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A liquid crystal display assembly, comprising:
an upper substrate;
a lower substrate disposed parallel to the upper substrate;
a liquid crystal layer enclosed between the upper and lower substrates;
an upper polarizer attached to a side of the upper substrate away from the liquid crystal layer;
a lower polarizer attached to a side of the lower substrate away from the liquid crystal layer; and
at least one supersonic wave sensor and a control chip,
wherein the at least one supersonic wave sensor is arranged between the upper and lower polarizers, and each supersonic wave sensor is electrically connected to the control chip.

2. The liquid crystal display assembly of claim 1,
wherein the upper substrate comprises an upper glass substrate and a color filter (CF);
wherein a lower surface of the upper glass substrate is adjacent to the liquid crystal layer;
wherein the CF is attached to an upper surface of the upper glass substrate; and
wherein the CF comprises pixel color blocks and a first black matrix arranged between the pixel color blocks.

3. The liquid crystal display assembly of claim 2,
wherein the lower substrate comprises a lower glass substrate and a thin film transistor (TFT) array;
wherein an upper surface of the lower glass substrate is adjacent to the liquid crystal layer; and
wherein a lower surface of the lower glass substrate is provided with the TFT array and a second black matrix arranged between TFTs of the TFT array.

4. The liquid crystal display assembly of claim 3, wherein the supersonic wave sensor comprises at least one transmitting terminal and one receiving terminal, the at least one transmitting terminal being arranged on at least one of the first and second black matrices; and
the transmitting and receiving terminals alternately work under the control of the control chip.

5. The liquid crystal display assembly of claim 3, wherein the supersonic wave sensor comprises one transmitting terminal and at least one receiving terminal, the at least one receiving terminal being arranged on at least one of the first and second black matrices; and
the transmitting and receiving terminals alternately work under the control of the control chip.

6. The liquid crystal display assembly of claim 5, wherein the supersonic wave sensor and the control chip are connected via a conducting wire arranged at least partially on the first black matrix.

7. The liquid crystal display assembly of claim 5, wherein the supersonic wave sensor and the control chip are connected via a conducting wire arranged at least partially on the second black matrix.

8. The liquid crystal display assembly of claim 5, comprising a plurality of supersonic wave sensors evenly and dispersedly arranged on the lower glass substrate.

9. The liquid crystal display assembly of claim 8, further comprising at least one backlight source electrically connected to the control chip.

10. The liquid crystal display assembly of claim 9, wherein a display region of the liquid crystal display assembly is divided into a plurality of display blocks, each display block is correspondingly provided with at least one backlight source and at least one supersonic wave sensor.

11. An electronic device comprising a liquid crystal display assembly according to claim 1.

12. The electronic device according to claim 11, wherein the upper substrate comprises an upper glass substrate and a color filter (CF); a lower surface of the upper glass substrate is adjacent to the liquid crystal layer; the CF is attached to an upper surface of the upper glass substrate; and the CF comprises pixel color blocks and a first black matrix arranged between the pixel color blocks.

13. The electronic device according to claim 12, wherein the lower substrate comprises a lower glass substrate and a thin film transistor (TFT) array; an upper surface of the lower glass substrate is adjacent to the liquid crystal layer; and a lower surface of the lower glass substrate is provided with the TFT array and a second black matrix arranged between TFTs of the TFT array.

14. The electronic device according to claim 13, wherein the supersonic wave sensor comprises at least one transmitting terminal and one receiving terminal, the at least one transmitting terminal being arranged on at least one of the first and second black matrices; and
the transmitting and receiving terminals alternately work under the control of the control chip.

15. The electronic device according to claim 13, wherein the supersonic wave sensor comprises one transmitting terminal and at least one receiving terminal, the at least one receiving terminal being arranged on at least one of the first and second black matrices; and
the transmitting and receiving terminals alternately work under the control of the control chip.

16. The electronic device of claim 13, wherein the supersonic wave sensor and the control chip are connected via a conducting wire arranged at least partially on the first black matrix.

17. The electronic device of claim 16, wherein the supersonic wave sensor and the control chip are connected via a conducting wire arranged at least partially on the second black matrix.

18. The electronic device of claim 15, comprising a plurality of supersonic wave sensors evenly and dispersedly arranged on the lower glass substrate.

19. The electronic device of claim 18, further comprising at least one backlight source electrically connected to the control chip.

20. The electronic device of claim 19, wherein a display region of the liquid crystal display assembly is divided into a plurality of display blocks, each display block is correspondingly provided with at least one backlight source and at least one supersonic wave sensor.
